(19) United States
(12) Patent Application Publication
(10) Pub. No.: US 2013/0081921 A1
(43) Pub. Date: Apr. 4, 2013

(54) SPRING RING

(71) Applicant: GKN Driveline Koping AB, Koping (SE)

(72) Inventors: Hans-Peter Nett, Adenau (DE); Jan Haupt, Kurten (DE)

(73) Assignee: GKN Driveline Koping AB, Koping (SE)

(21) Appl. No.: 13/631,370

(22) Filed: Sep. 28, 2012

(30) Foreign Application Priority Data
Sep. 30, 2011 (EP) 11 183 512.0

(51) Int. Cl. F16D 13/58; F16D 25/12

(52) U.S. Cl. 192/101

(57) ABSTRACT

A spring ring formed by a supporting ring, which is used as a spreading element for a multi-disc clutch is disclosed. The spring elements are formed by notches in a leg of the supporting ring.

### TECHNICAL FIELD

This disclosure relates to a spring ring as a spreading element of a clutch device, for example, in a hydraulically actuated multi-disc clutch. The spring ring comprises a supporting ring.

### BACKGROUND

Clutch devices, such as hydraulically actuated multi-disc clutches, are used inter alia in clutch-controlled compensation units of motor vehicles. Drive forces are conducted in a targeted, metered manner to the wheel of the connected axle and the dynamic driving behavior of a vehicle is influenced thereby. Moreover, such a clutch can act as part of a compensation unit of a motor vehicle in order to realize a secondary part of a drive train which can be switched on or decoupled (for example, an all-wheel drive which can be switched on and off), in that the secondary axle and the secondary axle drive wheels can be decoupled from the flow of drive power or coupled into the same by opening the clutch. For the above-mentioned applications it is necessary for the clutches to close and open promptly and to respond rapidly and reliably to ensure the intended regulation behavior. EP 2 116 411 Al discloses such a clutch-controlled compensation unit, with or without a differential, as part of a secondary drive train which can be switched on or off.

The opening of the clutch is supported by spring elements. The spring elements, push back a pressure piston, which is used for clutch actuation and is generally hydraulically operated, when the clutch is opened, so that the discs of a disc assembly, that is, inner and outer discs, can detach and move apart sufficiently from each other. The aim is to be able to rotate adjacent discs after the clutch has opened completely so freely that a clutch can run dry with the secondary axle drive train decoupled in order to be able rotate as well in a largely loss-free manner.

As the moment transmitted to a secondary axle drive wheel via the clutch can be influenced in a selective manner by means of the clutches in order to influence the dynamic driving behavior of the vehicle, the spring characteristic of the springs used is relevant for the exactly controlled actuation of the clutch. It should therefore be possible to produce the spring characteristic in as linear and well reproducible a manner as possible.

In addition, the installation space available in the compensation units is extremely restricted, and efforts are generally made to keep the number of parts to be installed as small as possible.

### SUMMARY

A spring ring is disclosed for use as a spreading element of a clutch device, which can be produced cost-effectively and with an easily reproducible spring characteristic, which requires the use of as few parts as possible and which is suitable for use in a compensation unit of a drive train of a motor vehicle having a clutch device, by which the connected drive wheels can be removed from the flow of drive power or engaged in the same in a controlled manner and/or by which the connected drive wheels can be actuated in a controlled manner.

A multiplicity of spring elements is provided over the circumference of the supporting ring, which elements are formed as notches out of the supporting ring material.

In one exemplary arrangement, the supporting ring has a first leg, out of which the spring elements are notched, and a second leg, which is angled downwards, preferably, in one exemplary arrangement, at right angles, starting from the base of the first leg. The second leg permits the spring ring to be centred, inter alia, relative to the clutch device and the further adjacent parts.

Moreover, the supporting ring can have a third leg which is angled downwards, and in one exemplary arrangement, preferably at right angles, starting from the second leg. The third leg and the first leg may run parallel, it being possible for the first leg to extend radially outwards starting from the second leg and for the third leg to extend radially inwards starting from the second leg, so that an approximately Z-shaped cross section of the supporting ring is produced.

The above configuration allows the supporting ring to extend in the axial direction by means of the second leg arranged between the first and third legs in order to bridge the axial space within the clutch assembly. One and the same supporting ring can thereby not only serve the function of spreading the clutch device but also act as a functional part to other parts of the clutch. In particular, the spring ring can form a bearing disc for an axial rolling bearing, in particular for an axial roller bearing or an axial needle bearing, the rolling body running face being provided by the third leg. This makes a particularly compact shape possible and ensures that the notched spring elements are always positioned at a precisely defined distance from the axial bearing via which the actuation forces are introduced into the clutch discs.

The use of the spring ring described above and below as an opening spring for a multi-disc clutch, in particular for a hydraulically actuated multi-disc clutch, is considered an independent invention and is claimed separately.

Further features and advantages of the invention can be found in the subclaims and in the following description of preferred exemplary embodiments using the drawings.

### BRIEF DESCRIPTION OF THE DRAWINGS

In the drawings,

FIG. 1 shows a clutch assembly having a spring ring shown in FIG. 2, and

FIG. 2 shows the spring ring of FIG. 1 in a detailed view.

### DETAILED DESCRIPTION

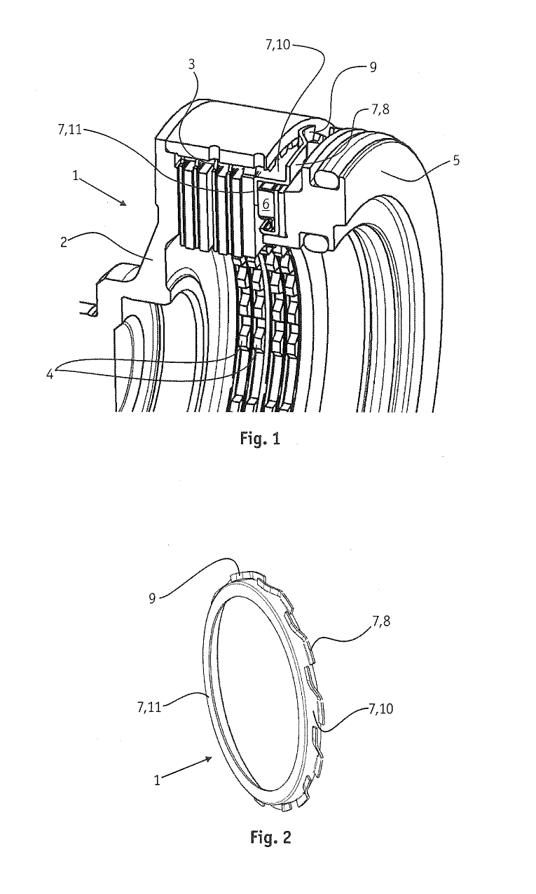

FIG. 1 shows a clutch assembly 1. A clutch moment is transmitted via an outer disc carrier 2 and a disc assembly consisting of outer discs 3 and inner discs 4 to an inner disc carrier (not shown). To actuate the clutch, a hydraulically loaded, ring-shaped pressure piston 5 acts on the disc assembly via an axial roller bearing 6.

A leg 11 of a supporting ring 7 with an approximately Z-shaped cross section is provided between the axial roller bearing 6 and the first clutch disc, on which the pressure emanating from the axial bearing 6 is directly exerted. This supporting ring forms on one side together with a first, vertically aligned leg 8, a spring ring having a plurality of spring tongues 9 distributed over the circumference thereof, which act between the outer disc carrier 2 and the supporting ring 7 in order to drive the pressure piston 5 and the outer disc carrier 2 apart when the clutch is to be opened.

The cross section of the supporting ring 7 has a central, horizontally aligned leg 10, by which the axial space occupied by the axial bearing 6 is bridged. A nested, particularly space-saving design is thereby made possible. A third leg 11, which acts as a running disc for the axial roller bearing, adjoins the second leg 10.

In order to reduce the number of parts and achieve a further minimization, in particular of the axial installation space requirement, in the clutch assembly 1 shown, a supporting ring 7 with an approximately Z-shaped cross section is used, in which the spring elements are formed by a multiplicity of spring tongues 9 notched out of the supporting ring material. These spring tongues 9 are deflected in the axial direction by notching out of the material of the first leg 8, and the spring force during compression is supported on a section of the first leg which is not notched. The spring tongues are preferably notched tangentially, as shown in the figures. They therefore extend in the tangential direction starting from the first leg and pivot about an imaginary radial axis on compression. A different type of alignment is however conceivable.

The spring characteristic and response behaviour of such a spring ring is well-suited to the use described in the introduction in a clutch-controlled compensation unit. The spring characteristic can be influenced in a targeted manner and adapted optimally to the requirement of the respective application by varying the number, length, width and the angle at which the spring tongues project from the first leg 8, and by the selection of the supporting ring material. A separate bearing disc is not necessary owing to the formation of a bearing running face on the third leg 11.

In summary, the invention relates to a spring ring formed by a supporting ring, which is used as a spreading element for a multi-disc clutch. The spring elements are formed by notches in a leg of the supporting ring.

1. A spring ring for use as a spreading element of a clutch device, comprising a supporting ring, wherein a multiplicity of spring elements is provided over the circumference of the supporting ring, which are formed as notches out of material making up the supporting ring.

2. The spring ring according to claim 1, wherein the supporting ring has a first leg, out of which the spring elements are notched, and a second leg, which is angled downwards, starting from a base of the first leg.

3. The spring ring according to claim 2, wherein the supporting ring has a third leg, which is angled downwards, starting from the second leg.

4. The spring ring according to claim 3, wherein the third leg and the first leg run parallel to each other and wherein the first leg extends radially outwards starting from the second leg, and the third leg extends radially inwards starting from the second leg.

5. The spring ring according to claim 3, wherein the spring ring forms a bearing disc for an axial rolling bearing, wherein the third leg forms a rolling body running face.

6. Use of a spring ring according to claim 1 as an opening spring for a, in particular for a hydraulically actuated multi-disc clutch.

7. The spring ring according to claim 2, wherein the second leg is angled downwards at a right angle starting from the base of the first leg.

8. The spring ring according to claim 3, wherein the third leg is angled downwards at a right angle starting from the second leg.
